(19) United States
(12) Patent Application Publication
(10) Pub. No.: US 2002/0031219 A1
(43) Pub. Date: Mar. 14, 2002

(54) Transmitter, receiver and transceiver arrangement

(75) Inventors: Jan Gutsche, Berlin (DE); Irenaeus Schoppa, Berlin (DE)

Correspondence Address: HAHN LOESER & PARKS, LLP, TWIN OAKS ESTATE, 1225 W. MARKET STREET, AKRON, OH, 44313, US

(73) Assignee: Technische Universitaet Berlin

(21) Appl. No.: 09/907,115

(22) Filed: Jul. 17, 2001

(30) Foreign Application Priority Data
Jul. 18, 2000 (DE) 100 36 372.5

(51) Int. Cl. H04L 9/00

(52) U.S. Cl. 380/28

(57) ABSTRACT

A transmitter, a receiver and a combined transceiver arrangement (50) exchange data with external devices through a serial transmission channel. According to this invention, the transmitter (52) comprises encoding means (60, 64, 68, 70), and the receiver (54) comprises decoding means (60, 74, 76, 80). The invention is explained in detail using a design example of a crypt UART component (50).

The invention relates to a transmitter according to the characterizing clause of claim 1. Furthermore, the invention relates to a receiver according to the characterizing clause of claim 18. Finally, this invention relates to a transceiver arrangement having both a transmitter unit and a receiver unit of the present invention.

### BACKGROUND OF THE ART

Data exchange between devices is performed by means of unidirectional transmitters or receivers, or integrated bi-directional transmitter-and-receiver arrangements. Data transmission usually occurs through transmission channels using pre-determined types of data. This invention deals with transmitters, receivers or transmitter-and-receiver arrangements, also referred to as “transceivers,” for a type of data consisting of binary-coded data proceeding in time sequence. In further text, data of this nature shall be also called serial data. The transmission channel can be of various physical forms. Data can be transmitted, e.g., in the form of electrical signals, or as electromagnetic signals in the light or conventional radio frequencies—or also in the form of acoustic signals.

In the field of electronics, there exist integrated transmitter/receiver components that form an interface between a data bus of a processor, e.g. a Central Processing Unit (“CPU”) of a computer, and a connected peripheral device, which receives and transmits serial data. An example of a peripheral device is a modem connected to the computer.

An example of such a component is the Universal asynchronous receiver/transmitter (“UART”) of the type PC16550D (National Semiconductor: data sheet PC16550D Universal asynchronous receiver/transmitter with FIFOs, National Semiconductor Corp., Santa Clara, June 1995; http://www.national.com/ds/PC/PC16550D.pdf). This UART component represents an electronic switching device, which converts binary-coded data received as isochronous (parallel) by the data bus into serial data, and which is also designed to convert serial data into parallel data. For this purpose, the known UART component includes a transmitter unit with an input for parallel data. A data converter designed as a parallel/serial converter is connected with the data input and converts the incoming parallel data into serial data, which are then conducted to a downstream serial data output. At the same time, there exists a second data input designed to receive incoming serial data from the peripheral device, and this input is connected with the serial/parallel converter. This converter converts the serial data received at the second data input into parallel data, which are then conducted to a connected data bus through a parallel data output. The parallel data input and the parallel data output in the known UART component are physically identical.

The known UART component also ensures data security, data verification, cycle and character synchronization as well as the control of the transmission with various transmission parameters. The known UART component is equipped with an 8-bit system interface for the connection to a microprocessor system, and with two 1-bit interfaces including handshake signals for the connection to a peripheral unit. The 8-bit system interface is designed for three address links, eight data links and several control signals. The two 1-bit interfaces include one transmission link, one reception link and several handshake signals.

The growing volume of transmitted confidential data increases the importance of encoding techniques. However, the disadvantage of the currently used encoding techniques is that they are software-based and that, therefore, they increase the load of the central processing system. On the one hand, such solutions of data encoding are costly, and, on the other hand, they can result in a delay in the transmission of encoded data.

Therefore, the underlying technical problem [and task] of this invention is to further develop a transmitter, a receiver and a transmitter/receiver arrangement of the type indicated at the beginning in such a manner as to make possible transmission of encoded data with little cost.

### SUMMARY OF THE INVENTION

This problem for a transmitter is resolved by a subject with the characteristics of claim 1. For a receiver, this problem is resolved by a subject with the characteristics of claim 18. For a transceiver, this problem is resolved by a subject with the characteristics of claim 87. The transceiver of this invention includes a transmitter unit with the characteristics of claim 1, and a receiver unit with the characteristics of claim 18. Any future reference to the transmitter according to this invention also includes the transmitter unit of the transceiver. Similarly, any data and indication of the receiver according to this invention also refer to the receiver unit of the transceiver. Any information about the transmitter unit or the receiver unit of the transceiver of this invention is also applicable to the transmitter or the receiver. The terms “transceiver” and “transmitter/receiver arrangement” are considered synonymous.

This invention is based on the idea of integrating an encoding device into a transmitter or a decoding device into a receiver, or both an encoding device and a decoding device into a transmitter/receiver arrangement.

The encoding device used according to this invention is placed between the data converter and the data output of the transmitter. However, this does not exclude the possibility that certain units serving the purpose of encoding can be placed in a different spot of the transmitter unit, e.g., an a parallel array to the data converter. In any case, the encoding device is arranged in such a manner that the actual data encoding occurs between the output of the converter and the data output. The reason for this measure is the realization that—in view of the number of cycles required for the encoding process—the encoding of data bit per bit occurs most advantageously there, where the data are available in serial form. With this arrangement of the encoding device, no additional cycles are required for additional conversion of the data before their encoding. The encoding process can proceed bit per bit, cycle per cycle without delaying the data flow at the data output of the transmitter.

The encoding device is designed accordingly for the conversion of serial data. The non-encoded data at the input of the encoding device are serial and the encoded data at the output of the encoding device are serial, too. However, this invention does not pre-determine any specific encoding algorithm. All known encoding algorithms may be used.

The aforementioned information applies to the decoding device of the receiver accordingly. It is to be placed between the data input of the receiver and the data converter of the receiver. However, this does not exclude the possibility that certain units serving the purpose of data decoding can be placed in a different spot of the receiver unit, e.g., an a parallel array to the data converter. In any case, the decoding device is arranged in such a manner that the actual data decoding occurs between the serial data input of the receiver and the input of the data converter. Based on such arrangement of the decoding device, the encoded serial data received at the data input can be decoded immediately during the forwarding to the data converter. Thus the decoding device is designed to convert encoded serial data into decoded serial data.

It becomes clear that, for the solution according to this invention, it is of no importance which special (second) data type is supported by the data input of the transmitter or the data output of the receiver. Essential for this invention is the provision of serial data by the transmitter and the serial data reception by the receiver. Therefore, the application range of this invention extends to various transmitters or receivers. There may be, e.g., analog data in the form of one (or several) time dependent non-digitized electrical voltage(s) or light intensities that arrive at the data input of the transmitter or come out of the data output of the receiver. From the time aspect, these data might be present at the data input of the transmitter or at the data output of the receiver in serial or parallel form.

The following text separately describes technical versions of the transmitter and the receiver according to this invention.

In one design version, the transmitter includes a transmission shift register that is connected with the encoding device. The transmission shift register is designed for the reception of binary-coded data and for a serial output of binary-coded data. The data received by the transmission shift register are conducted to it from the data input. A special design example demonstrates 8 parallel data bits received by the transmission shift register that are conducted to it from an internal 8-bit data bus of the transmitter.

The encoding device of one embodiment comprises a key register that is designed for the reception and output of a definable binary key with a pre-determined number of bit positions. In this design version, a binary key can be loaded into the key register before the start of a communication process. This design allows, if necessary, to use a different binary key for each communication process, which makes the decoding of outgoing data by unauthorized persons even more difficult.

In another version of this design example, the key register of the transmitter is connected with the data input. This allows receiving a binary key (to be used for the encoding) from a device connected with the data input, e.g., from a central processing unit of a computer. In this design version, the transmitter does not need to be equipped with its own memory and control means for the management of various binary keys.

In another design version of this invention, the encoding device comprises an encoding component that is connected, at its input side, with the data converter and that is designed for the encoding of data received from the data converter. The encoding component is independent from the resources managed by a device connected with the data input of the transmitter. Thus, the encoding requires no external computing equipment, e.g., a CPU. In this way, the transmitter according to this invention achieves a certain load alleviation for the device(s) connected to the input. In a special design version, the encoding component can be designed in the simple form of a hardwired switch.

A design version of the transmitter according to this invention comprises an encoding component that is connected, at its input side, with the key register. This allows combining the advantageous effects of a key register and an encoding component. However, the external device, which can—if necessary—be used to generate and/or provide a binary key to the transmitter, is otherwise not involved in the data encoding.

The encoding device of one embodiment comprises a pseudo-random sequence generator, which is designed to generate and provide a binary-coded pseudo-random digit sequence. The pseudo-random sequence generator is connected, at its output side, with the encoding component. The generated pseudo-random digit sequence is conducted to the encoding component, which uses it for encoding of bit streams coming from the data converter. It is especially advantageous to connect the pseudo-random sequence generator, at its input side, with the key register. The generation of pseudo-random digit sequence can occur on individual binary keys. This allows making the number of possible pseudo-random digit sequences practically infinite.

The following text describes advantageous design versions of the receiver according to this invention. These versions are mostly designed in a manner compatible with one of the aforementioned transmitters. The advantages of the design versions of a receiver described below become clear from the aforementioned advantages of the relevant design versions of the transmitter described above. Furthermore, there are advantages already in the compatibility between the transmitter and the receiver, since the application of the transmitter and the receiver in separate devices guarantees smooth communication between such devices.

The data converter of the receiver of the invention comprises a reception shift register, which is designed for a serial reception of binary-coded data and for their output. In another design version of the receiver, the decoding device comprises a key register designed for the reception of a definable binary key with a pre-determined number of bit positions.

Essentially, a fixed binary key can be used during the operation. However, the key register should be connected with the data input. This allows inputting of keys from outside, their storage in the key register and their use for the decoding of incoming data. An additional connection of the key register with the data output also allows storing of keys that were put in from outside in an external memory medium, e.g. on the hard disk of a computer. This is especially meaningful if, e.g., customized keys are used to verify the identity of a transmitter sending in data.

In another design version of this invention, the decoding device comprises an decoding component that is connected, at its output side, with the data converter and that is designed for the decoding of data received from the data input. The advantages of this design version become clear by analogy with the advantages of the above described design version of a transmitter according to this invention with an encoding component. Therefore, in another design version, the decoding component is also connected with the key register of the receiver.

In one design version, the decoding device comprises a pseudo-random sequence generator, which is designed to generate and provide a binary-coded pseudo-random digit sequence. The pseudo-random sequence generator is connected, at its output side, with the decoding component and, in another design version, typically on its input side, with a key register.

The structural uniformity of the transmitter and the receiver as for the encoding and decoding algorithms allows a simple standardized data encoding and decoding, for which only the actually used binary keys must be exchanged between the transmitter and receiver.

The following text describes further joint versions of the transmitter and receiver. It is understood that any information also refers to the respective transmitter unit or the receiver unit of a transmitter/receiver arrangement according to this invention unless something else is explicitly mentioned.

In many design versions, the transmitter or the receiver comprises a crypt control register that is, on its output side, connected with the encoding component or with the decoding component, and designed for the reception and output of binary-coded control data. In one version, the transmitter/receiver arrangement comprises a joint crypt control register for the transmitter unit and the receiver unit. Using the control data contained in the crypt control register, individual units of the encoding and decoding devices can be activated and deactivated.

In another design version, the crypt control register is connected with the key register. This allows controlling the write entitlement to overwrite the key register with a new binary key. In another design version, the pseudo-random sequence generator of the transmitter of the receiver comprises a sequence generator switch containing a shift register connected with a regenerative coupling. The use of such sequence generator circuits is well known. They are especially suitable for the use in the transmitter or receiver according to this invention, since they allow a very simple implementation of efficient hardwired encoding and decoding circuits.

The feedback shift register is usually designed in such a manner as to form a linear feedback function. Such linear feedback shift registers are implemented by means of a module-2-addition, i.e., a bit-wise XOR connection of certain bits of the shift register. With the right selection of the feedback 2ⁿ function, an n-bit shift register with a linear feedback assumes various internal statuses.

This property is utilized in a further developed form of this design version, in which the feedback shift register is designed in such a manner that the feedback function is a primitive polynomial module two. Such polynomial, also called an irreducible polynomial of n degree (where n is the number of bit positions of the shift register) the sequence of output bits of the shift register reaches the maximum achievable period of 2ⁿ−1. This means that the first repetition of digit sequences provided by the pseudo-random sequence generator occurs only after 2ⁿ−1 performed shift operations. On the basis of this property, the choice of a sufficiently great value of n allows to generate infinitely long, i.e., almost ideal, random digit sequences that are used for encoding or decoding in the transmitter or receiver according to this invention.

In another design version of the transmitter or receiver according to this invention, the shift register of the sequence generator circuit designed in such a manner that a part of the shift register simultaneously assumes the function of the key register. This eliminates the necessity to integrate a separate key register.

This design version can be constructed, e.g., in such a manner that the shift register of the sequence generator circuit is formed by several sub-registers connected in series that are designed for a parallel reception of a part of the binary key consisting of a pre-determined number of bit positions, where the sub-register connected last in series is designed for a serial output of the part of the binary key contained therein, and the remaining sub-registers are designed for a parallel output of the part of the binary key contained in each of them to the sub-register next in sequence. In this design version the transfer of a binary key requires only a few cycles, since always several, e.g., 8 bit positions of the binary key are transferred simultaneously.

The shift register of the sequence generator circuit typically comprises a number of flip-flops connected in series, where the highest-value bit position is assigned to the flip-flop that is first in sequence, the next-value bit position is assigned to a second flip-flop connected, at its input side, with the output of the first flip-flop, and so forth, until the lowest-value bit position is assigned to the last flip-flop. The sequence generator circuit can additionally comprise a first XOR gate introduced after the last flip-flop of the shift register, where the outputs of pre-determined flip-flops are connected with the inputs of this gate, and the gate's output is connected with the input of the first flip-flop and with the data output of the transmitter or with the reception shift register of the receiver.

The encoding component of the transmitter or the decoding component of the receiver can, in a simple design, comprise a XOR gate, whose inputs are connected with the output of the pseudo-random sequence generator and the data converter of the transmitter or with the data input of the receiver. The output of the XOR gate is connected with the data output of the transmitter or with the data converter of the receiver. Based on the value table of an XOR gate, the decoding of files cryptographically encoded with such an encoding component is only possible if the receiver has at its disposal a decoding unit of the same structure as the encoding unit. In addition, the binary keys used and the actual bit generated by the pseudo-random sequence generator must match cycle per cycle.

In another design version, the key register is wired in such a manner that the write access to the key register can be activated or deactivated by means of a control bit contained in the crypt control register. Based on a specific wiring, the encoding and decoding can also be activated or deactivated by means or a control bit.

Transmitters or receivers can be designed as integrated circuits in a transmitter component or a receiver component. The design of an ASIC (Application Specific Integrated Circuit) allows adjustment to specific user requirements. Here again, we wish to point out the wide range of the application possibilities of this invention.

The transmitter/receiver arrangement is also usually designed as an integrated circuit in a transmitter/receiver component.

One particular design version of the transmitter/receiver arrangement according to this invention is characterized in that the data input of the transmitter unit is designed to receive binary-coded (parallel) data structures containing several parallel bit positions, that the data converter of the transmitter unit is a parallel/serial converter, which is designed to convert a parallel data structure into serial data, and that the data converter of the receiver unit is a serial/parallel converter, which is designed to convert serial data into parallel data structures.

Such a transmitter/receiver arrangement can be designed as an UART component (Universal Asynchronous Receiver Transmitter). Such a crypt UART component allows utilizing the advantages of widely used standards of this component type so that a compatibility with well-known similar components without encoding and decoding capability can be achieved.

The UART according to this invention can comprise a register record and a control data record that contain all register and control data of a UART component of the mentioned well-known type PC16550D.

An addressing system of the key register and the crypt control register in a read-only mode and a write mode compatible with the UART component of the PC16550 type guarantees software compatibility.

### BRIEF DESCRIPTION OF THE DRAWINGS

Additional characteristics and advantages of this invention are demonstrated by the following description of some design examples using drawings, wherein:

FIG. 1 shows a simplified block diagram of a transmitter component according to this invention;

FIG. 2 shows a simplified block diagram of a receiver component according to this invention;

FIG. 3 shows a simplified block diagram of a design example of a transmitter/receiver component according to this invention;

FIG. 4 shows a somewhat more detailed block diagram of a transmitter unit of the transmitter/receiver component of FIG. 3;

FIG. 5 shows a somewhat more detailed block diagram of a receiver unit of the transmitter/receiver component of FIG. 3;

FIG. 6 shows a design example of a circuit for a pseudo-random sequence generator; and

FIG. 7 shows another illustration of the pseudo-random sequence generator from FIG. 6.

### DETAILED DESCRIPTION OF THE INVENTION

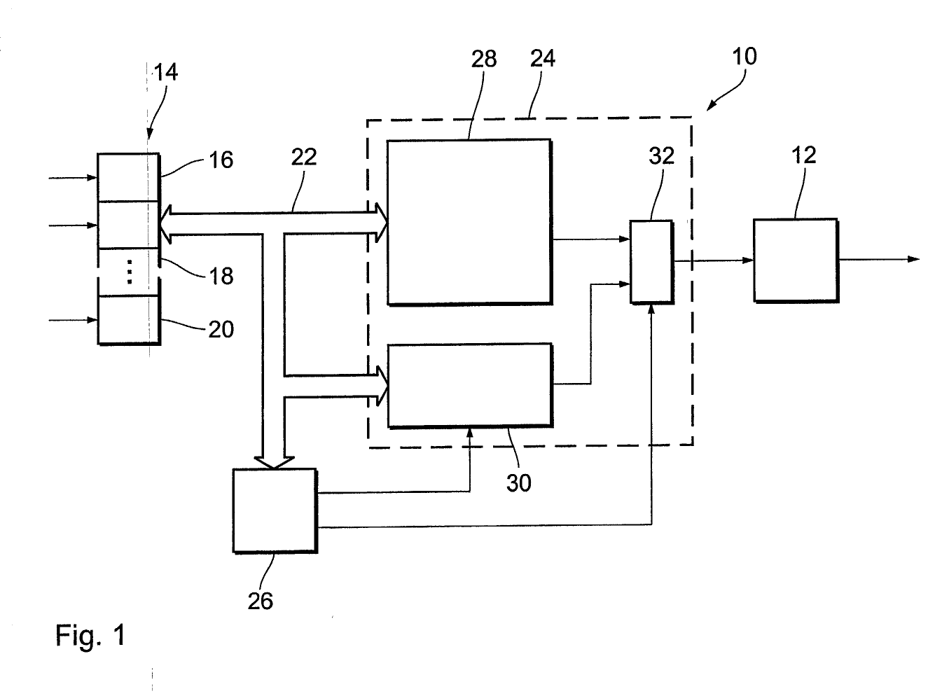

FIG. 1 shows a simplified block diagram of a transmitter component 10. This transmitter component is designed to provide binary-coded serial data at an output 12—here an electrically conductive contact pin. Component 10 receives the data to be transmitted from outside through a parallel data input 14. Parallel input 14 consists of a number of electrically conductive contact pins, of which only three contact pins (16, 18, and 20) are illustrated here for the sake of simplicity. Typically, parallel input 14 contains eight contact pins. However, it is clear that design versions with fewer or more contact pins are possible, too. Parallel input 14 can be connected, e.g., with the data bus of a computer's CPU.

Parallel input 14 is connected with an internal data bus 22 of the transmitter component 10 through units, which are not illustrated here in detail but which are well-known to any expert such as a cache. Equally connected with the data bus is a transducer and encoding unit 24 as well as a crypt control register 26. The transducer and encoding unit 24 comprises a parallel/serial converter 28, a crypt unit 30 connected with the output of the parallel/serial converter 28 as well as an encoding component 32. The encoding component 32 is connected, at its input side, with both the output of the parallel/serial converter 28 and the output of the crypt unit 30. Furthermore, the encoding component 32 is designed for reception of control data from the crypt control register 26.

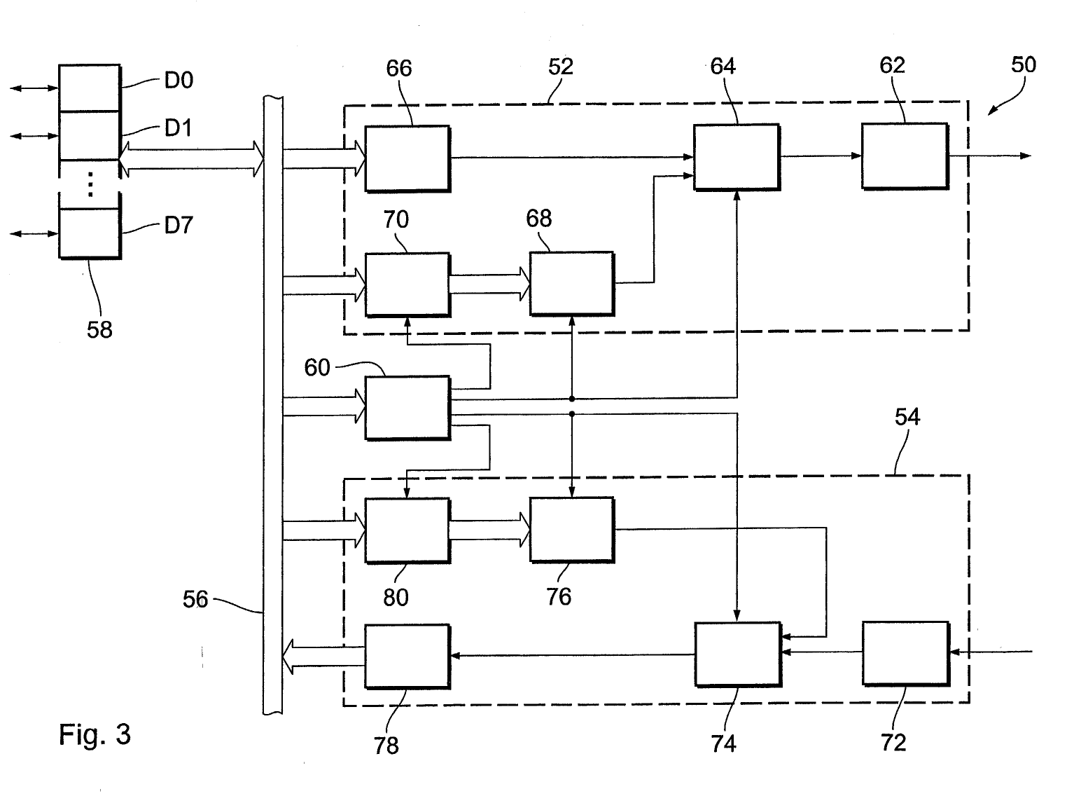

The following text explains in more detail the functioning of the integrated transmitter component 10. The data received at the parallel input 4 are forwarded through the internal data bus 22. The component 10 receives the target address for the incoming data through separate control inputs not illustrated here. The addressing within the component 10 is performed by selection and control logic not shown here but well known to any expert. More details can be found in the description of the design example in FIG. 3.

The incoming data at the parallel input 14 can include, among other types, binary plain text data, a binary key or crypt control data to be transmitted to the crypt control register 26. The crypt control data contained in the crypt control register 26 control, e.g., the operation of the encoding component 32. The encoding component 32 works in dependence on the transmitted crypt control data. Either non-encoded plain text data received from parallel/serial converter 28 are forwarded to output 12, or data received from parallel/serial converter 28 are encoded by means of a pseudo-random sequence received from the crypt unit 30 and then conducted to output 12.

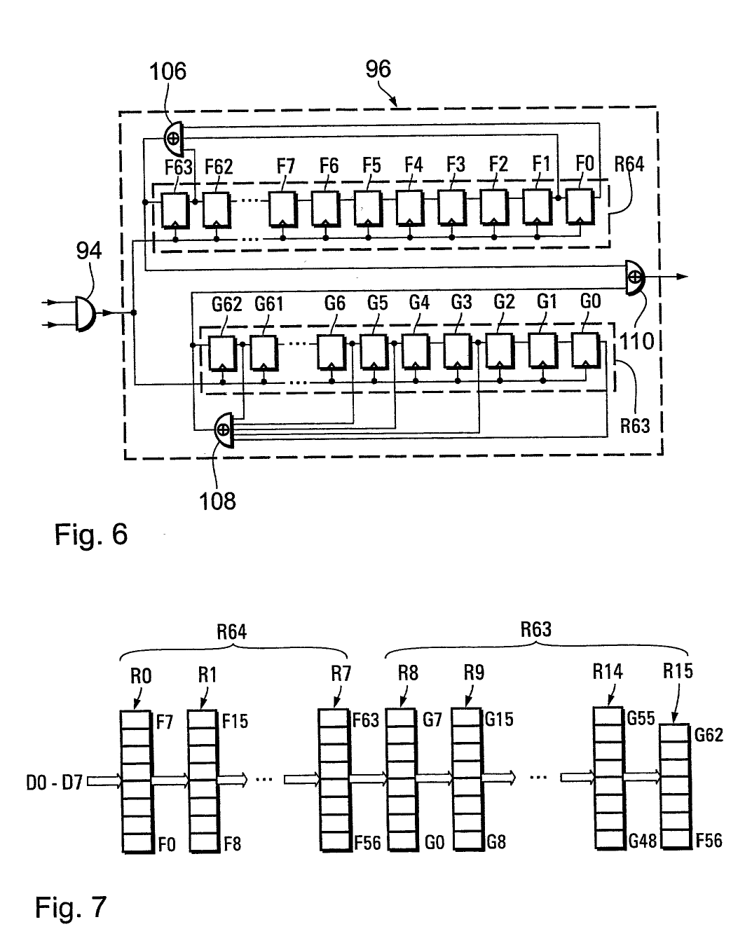

Other crypt control data contained in crypt control register 26 control the write entitlement during the transmission of a binary key to crypt unit 30. If the write entitlement is activated, the data received at parallel input 14 are stored in a key register of crypt unit 30. The design of such a key register is explained in detail further below using FIGS. 6 and 7. Serial data arriving at the input of the crypt unit are encoded according to an encoding algorithm using the binary key, and are further conducted to encoding component 32. The details of the encoding algorithm are also explained below using FIG. 6.

Integrated transmitter component 10, which is illustrated here only in its essential characteristics, fulfills the function of an interface between a CPU and, e.g., a connected modem. Instead of a modem, also other converters can be connected such as an optical converter or a digital-analog converter. Transmitter component 10 relieves the CPU of the computing steps connected with the data encoding, since the encoding occurs by means of a hardware-based encoding algorithm immediately after the data received from the CPU have been converted from parallel data into serial data in the parallel/serial converter. While an encoding algorithm in hard wiring is contained in crypt unit 30, an individually adjustable binary key provides an effective protection against unauthorized reading of the data to be transmitted. An example of a hardwired-encoding algorithm is described below with the help of FIG. 6.

In a variant of this design example, the encoding in crypt unit 30 occurs by software. In this design version, the crypt unit comprises the required computing capability, especially a program memory and a processor to perform the computations required by the encoding program residing in the program memory.

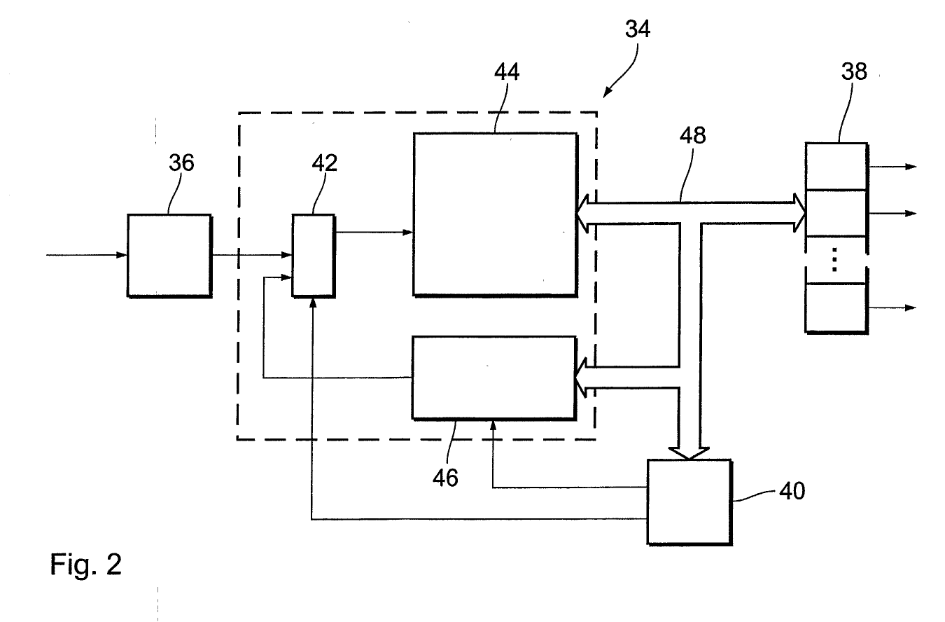

FIG. 2 shows, in a fairly simplified block diagram, a design example of receiver component 34 according to this invention. It represents an integrated receiver and decoding component. Like the integrated transmitter and encoding component shown in FIG. 1, component 34 shown in FIG. 2 fulfills the function of an interface. However, component 34 is designed for the reception of serial data, e.g., from a modem, at a serial input 36, and for parallel delivery of data to a parallel output, e.g., to a data bus of a CPU.

The data arriving at serial input 36 are, controlled by a crypt control register 40 by means of a decoding element 42, either conducted immediately to a serial/parallel converter 44, or they are decoded, by means of pseudo-random sequence generated by a crypt unit 46, and then conducted to the serial/parallel converter. Non-encoded, binary plain text data or data decoded by means of crypt unit 46 are conducted to parallel output 38 through serial/parallel converter 44 and an internal data bus 48.

Compared to an immediate forwarding, no additional cycle is required for the decoding of data. Decoded serial data are released by the crypt unit to serial/parallel converter 44. An internal data bus 48 connects serial/parallel converter 44 with parallel output 38 and crypt control register 40 as well as with crypt unit 46. Serial input 36 and parallel output 38 in receiver component 34 are designed, like the transmitter element in FIG. 1, in the form of contact pins. For the sake of simplicity, no detailed illustration and explanation are provided for other function units of such a component (which are well-known to an expert) such as selection and control logic or a modem control unit designed to control communication with a connected modem.

FIG. 3 shows, in a simplified block diagram, the structure of a design example of the transmitter and receiver component according to this invention. This example represents a UART (Universal asynchronous receiver transmitter) component, whose design includes the function of encoding and decoding of outgoing and incoming data, and which is called in further text crypt UART component 50.

Crypt UART component 50 comprises a transmitter unit 52 and a receiver unit 54. An internal data bus 56 connects the transmitter and receiver units 52 and 54 with a parallel data input and output 58. Parallel data input and output is formed by eight contact pins D0 to D7. Crypt UART component 50 is pin compatible with known URT components, e.g., type PC16550D (cf. National Semiconductor: data sheet PC16550D Universal asynchronous receiver/transmitter with FIFOs, National Semiconductor Corp., Santa Clara, June 1995).

In addition, a crypt control register 60 is also connected by internal data bus 56. The control data contained in crypt control register 60 control the operation of transmitter unit 52 and receiver unit 54 as will be explained in detail thereinafter.

Transmitter unit 52 releases serial data, through a TxD pin 62, to a connected device, e.g., a modem. An encoding element 64 with two data inputs and a control input is superposed to TxD pin 62. One data input is connected with a transmit shift register 66, while the other data input is connected with a crypt unit 68. The control input of encoding element 64 is connected with crypt control register 60. Control bit EE (Encryption Enable) received from crypt control register 60 controls the function modes of encoding element 64. If the control bit EE is set to (“1”), the data received from transmit shift register 66 are encoded by crypt unit 68 and conducted to TxD pin 62. If the control bit EE is not set, the data received from transmit shift register 66 are conducted to TxD pin 62 in a non-encoded form.

The crypt unit is connected, on its input side, with a key register 70. The key register includes 8 bit positions and represents a transfer interface from internal data bus 56 to crypt unit 68. The transfer of the key is possible only if a write control bit TWE in crypt control register 60 is set accordingly. Details of the transfer of the binary key to crypt unit 68 will be explained thereinafter using FIG. 7.

Transmitter unit 54 receives serial data from outside through a RxD pin 72. The received data are conducted to a decoding element 74. Decoding element 74 is connected, on its input side, with the output of a crypt unit 76. Crypt unit 76 of receiver unit 54 has the same structure as crypt unit 68 of transmitter unit 52.

The function modes of decoding element 74 are controlled by means of a control bit DE (Decryption Enable) contained in crypt control register 60. If the control bit DE is set, the data received at the input of decoding element 74 are decoded and forwarded from decoding element 74 to a receive shift register 78. If the control bit DECODING is not set, the data received from RxD pin 72 are conducted directly from decoding element 74 to receive shift register 78. The decoding and forwarding occurs in one single basic cycle.

Crypt unit 76 is connected, on its input side, with a key register 80. Key register 80 of receiver unit 54 has an identical design as key register 70 of the transmitter unit. Its function modes are controlled by crypt control register 60 by means of a control bit RWE. If this control bit is set, key register 80 of receiver unit 54 as well as a register contained in crypt unit 76 are open to receive a binary key for the overwriting.

If both control bits TWE and RWE are set, a binary key is conducted, through internal data bus 56, to both key register 70 of transmitter unit 52 and key register 80 of receiver unit 54. Relevant details are included in the description of FIG. 7.

The following text explains in more detail the structure of crypt UART component 50 using the enclosed Tables 1 and 2.

Table 1 indicates complete registers of the crypt UART component as shown in FIG. 3. The terminology of the registers follows the designations known from the UART component of type PC16550D and, therefore, is left in English. Seen from the left-hand side, the first three columns of Table 1 contain the three bit positions A2, A1 and A0 of the registers indicated in the relevant row. A0 designates the lowest-value bit position of the binary address, A1 designates the next higher-value, and A2 designates the highest-value bit position. The register addressing depends on the access mode. Depending on whether a register is to be read or to be written into, different registers can be controlled under one binary address. E.g., the binary address “000” in read mode controls a receive holding register (RHR), and the same address—in write mode—controls a transmit holding register (THR). A scratch pad register is accessible both in read mode and write mode. Therefore, the addressing “111” for this register is valid both in read mode and in write mode.

The register record of crypt UART component 50 of FIG. 3 contains all registers of a conventional UART component. These registers are located in the crypt UART component 50 under the same addresses as can be found in a conventional UART component.

However, the register record of crypt UART component 50 is—compared to the register record of a conventional UART component—expanded by two registers. New are the crypt control register that is designated as such in Table 1 (reference number 60 in FIG. 3), and the key register that is designated as such in Table 1 (reference numbers 70 and 80 in FIG. 3). Since in the register record of a conventional UART component the binary addresses “101” and “110” in write mode are not assigned to any register, they are assigned to the crypt control register and to the key register. Both registers are accessible only in write mode.

Table 2 provides the meaning of the 8 bit positions of the registers indicated in Table 1. The left column of Table 2 indicates the binary address of the relevant register. The following column indicates the abbreviation of the relevant register known from Table 1. The subsequent 8 columns indicate the meaning of the bit positions of each register. Bit<7> designates the most significant bit (MSB), and bit<0> designates the least significant bit (LSB).

The structure of the registers of crypt UART component 50 shown in Table 2 generally corresponds with the structure of a UART component type PC16550D. However, different from such a structure are the crypt control register and the key register already indicated in Table 1. The crypt control register contains the lowest four bit positions designed to control the encoding and decoding process by means of the key register (reference numbers 70 and 80 in FIG. 3) and of the encoding or crypt unit 68 or 76. The least significant bit position of the crypt control register contains the control bit “TWE” mentioned above. If this control bit is set (“1”), the key register 70 of transmitter unit 52 is open for overwriting. If this control bit is not set, the key register is blocked for any writing.

The next higher-value bit position of the crypt control register contains the control bit “RWE”. This control bit allows a similar control of the write access to key register 80 of receiver unit 54. Using both control bits “TWE” and “RWE”, it is possible to contact key register 70 of transmitter unit 52 and key register 80 of the receiver unit under the same binary address “101”. If both bit positions are set, both key registers 70 and 80 can be overwritten.

The third bit position bit<2> of the crypt control register contains the control bit “EE” already mentioned above. If the control bit “EE” (Encryption Enable) is set, crypt unit 68 is activated, encoding element 64 encodes the data received from transmit shift register 66, and forwards them to TxD pin 62. If the control bit “EE” is not set, crypt unit 68 is deactivated, and encoding element 64 forwards the data received from transmit shift register 66 in non-encoded form to TxD pin 62.

The fourth control bit DECODING of the crypt control register controls crypt unit 76 and decoding element 74 of the receiver unit. If the control bit DE is set, decoding element 74 decodes, by means of pseudo-random sequence generated by crypt unit 76, the data received from RxD pin 72, and forwards them to receive shift register 78. If the control bit DE is not set, the data received from the RxD pin are forwarded, through decoding element 74, directly to receive shift register 78.

The key register indicated in Table 2 under the binary address “110” shows the structure of both the key register 70 of transmitter unit 52 and the key register 80 of receiver unit 54. The key register contains 8 bit positions, which contain the bits “0” to “7” of a binary key. Using the key register, keys of any size can be forwarded to crypt unit 68 or to crypt unit 76. The number of bit positions of the binary key is pre-determined by the structure of crypt units 68 or 76.

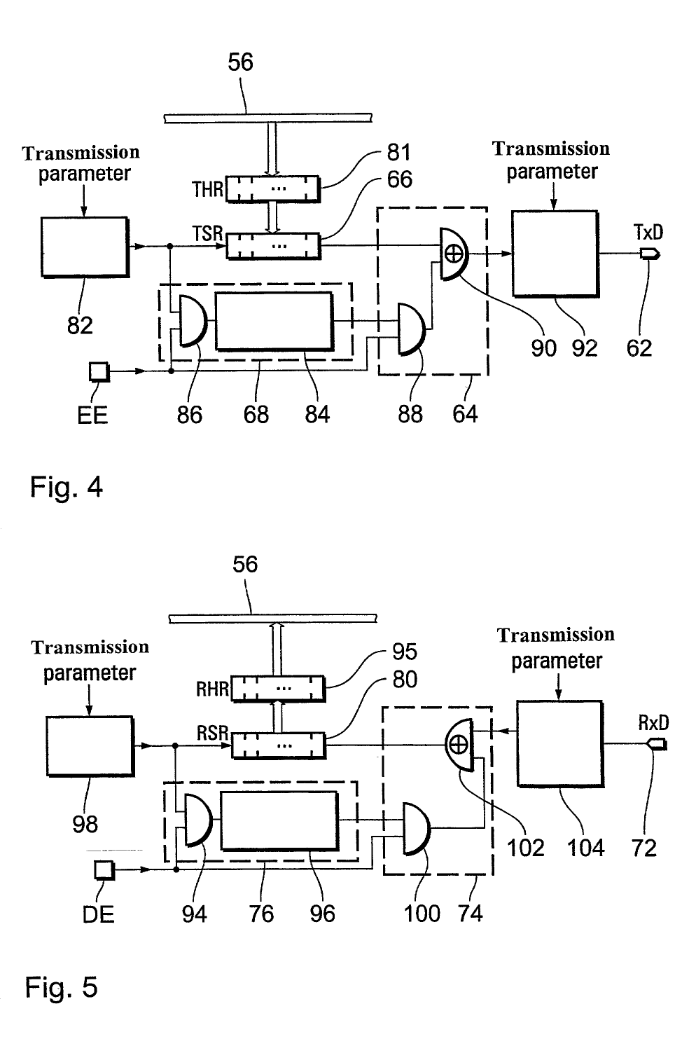

FIG. 4 illustrates, in a block diagram, details of transmitter unit 52 of crypt UART component 50 from FIG. 3. The following description and content can be also directly applied to the transmitter component from FIG. 1.

Compared to FIG. 3, FIG. 4 in addition illustrates, among other things, a transmit hold register (THR) 81 included between internal data bus 56 and the transmit shift register, and a baud rate generator 82. Both elements are well known from a conventional PC16550D type UART component. The baud rate generator generates a timing signal of a frequency depending on the transmission parameters of each particular communication process. Baud rate generator 82 triggers both transmit shift register (TSR) 66 and a pseudo-random sequence generator 84 contained in crypt unit 68. In the following text, the pseudo-random sequence generator is referred to as sequence generator 84.

Between baud rate generator 82 and sequence generator 84 is included a first UND gate, to whose both inputs arrive the timing signals of the baud rate generator and the control bit EE of crypt control register 60 (cf. Table 2 and FIG. 3). The first gate 86 causes that sequence generator 84 is activated only if the control bit EE is set.

Sequence generator 84 is designed to generate and release a binary random sequence. The following text explains the details of its design using FIGS. 6 and 7. With control bit EE set, each timing signal of baud rate generator 82 releases a data bit “0” or “1” on the output of sequence generator 84. This “encoded” data bit is forwarded to the input of a second UND gate 88, to whose second input arrives the control bit EE. The output of second UND gate 88 is connected with one input of XOR gate 90 (XOR=exclusive OR). At the input of XOR gate 90 is the output of transmit shift register 66. Second UND gate 88 and XOR gate 90 together form encoding element 64 from FIG. 3. Second UND gate 88 assumes the function to switch on or off the data encoding. If the control bit EE is not set, then—irrespective of the output status of sequence generator 84—the output of second UND gate 88 is “0”. With this value at one input of XOR gate 90, this gate produces at its output always the value that is at its other input, i.e., it forwards the bit received from transmit shift register 66 in a non-encoded form. If the control bit EE is set, then one input of XOR gate 90 has the value generated by sequence generator 84 in each basic cycle. Therefore, in this case, the output value of XOR gate 90 is dependent on the produced value of the pseudo-random sequence.

Based on the switching logic of XOR gate, the output value of XOR gate 90, which is released outside the system through TxD pin 62, does not disclose what value was released in each basic cycle by transmit shift register 66. The decoding requires a crypt unit that has an identical binary key and an identical decoding mechanism at its disposal, as is the case of crypt unit 84. This is made clearer when describing further Figures in the following text.

XOR gate 90 is followed by a start, stop and parity generator 92, which adds to the encoded data, in a non-encoded form, one start bit, one or two stop bits and, as an option, one parity bit. For this purpose, generator 92 accesses adjustable transmission parameter.

FIG. 5 shows, in the same layout as FIG. 4, more details of receiver unit 54. Here too, it is clear to an expert that the technical content described in the following text can be applied to receiver component of FIG. 2.

In addition to elements known from FIG. 3, FIG. 5 shows, among other things, a receive hold register (RHR) 95 (known from the component PC16550D) between internal data bus 56 and receive shift register 80.

Crypt unit 76 has the same structure as crypt unit 68. It consists of a first UND gate 94 and a following pseudo-random sequence generator 96. The operation of the crypt unit is controlled by the control bit DECODING contained in crypt control register 60 in the same manner as the operation of crypt unit 68 is controlled by the control bit EE. The crypt unit is also connected with a baud rate generator 98 in the same manner as crypt unit 68 is connected with baud rate generator 82. Based on the asynchronous data transmission between crypt UART component 50 and external receivers or transmitters, the [missing word] of baud rate generator of transmitter unit 52 and the [missing word] of baud rate generator 98 of receiver unit 54 can differ from each other.

Decoding element 74 of receiver unit 54 comprises (as does encoding element 64 of transmitter unit 62) a second UND gate 100 following sequence generator 96. The output of second UND gate 100 is connected with the first input of XOR gate 102. The second input of XOR gate 102 is connected with RxD pin 72 through a start, stop and parity detector 104. Start, stop and parity detector 104 is designed to detect start bits, stop bits and parity bits received at RxD pin 72. These bits are used to control the timing of the communication process with the external transmitter, and they are not forwarded to decoding element 74. Only data cleared of the aforementioned control bits are forwarded to decoding element 74. The output of XOR gate 102 is connected with the data input of receive shift register 80, which is (as is the case of crypt unit 76) supplied with clock pulses by baud rate generator 98. The content of receive shift register 80 is forwarded to an internal data bus 56 through its parallel data output and a receive hold register 106 (RHR, cf. Tables 1 and 2).

As the described structure of the receiver unit makes clear, the decoding of received encoded data occurs in a manner similar to the encoding of the data to be sent in the transmitter unit. After a key is released to crypt unit 76 and with the control bit DE set, sequence generator 96 produces the same binary pseudo-random sequence as the external transmitter. Important for the decoding process is the synchronization between the crypt unit of the external transmitter and crypt unit 76. A data bit encoded externally according to the mechanism explained by means of FIG. 4 can be decoded by receiver unit 54 only if the sequence generators of the communicating units produce identical bits in each basic cycle.

Based on the synchronization between the sequence generators of the external transmitter unit and receiver unit 54, the data encoded by the external transmitter unit are decoded at XOR gate 102 and are forwarded, bit per bit, to receive shift register 80.

If the control bit DE is not set, the first input of XOR gate 102 shows constantly the value “0”. As a result, the data coming from RxD pin 72 are forwarded, in unchanged form, to receive shift register 80.

FIG. 6 shows, in a block diagram, a design example of a sequence generator. Such sequence generator is used both as sequence generator 84 of transmitter unit 52 and sequence generator 96 of receiver unit 54. An encoded communication between crypt UART component 50 and external transmitters or receivers is possible only if the latter have an identically designed sequence generator or at least a sequence generator with the same software. The sequence generator shown in FIG. 6 is marked with reference number 96 of the sequence generator of receiver unit 54. It comprises two shift registers with linear feedback functions. The first shift register R64 is a 64-bit shift register consisting of 64 flip-flops connected in series. These flip-flops are marked with F0 to F63 in FIG. 6. The input of flip-flop F63 is connected with the output of a XOR gate 106. The outputs of flip-flops F0, F1 and F63 are at the input of XOR gate 106. This circuit implements the irreducible polynomial P(x)=x⁶³⊕x⊕1 as the feedback function. Pseudo-random sequence generator 96 comprises a second 63-bit shift register R63 connected parallel with shift register R64. Its flip-flops are marked with reference numbers G0 to G62. Similarly as with the 64-bit shift register R64, the flip-flop G62 is connected, at its input, with the output of a second XOR gate 108. On the gate's five inputs are the outputs of flip-flops G0, G3, G5, G6, and G62. This circuit implements the irreducible polynomial Q(x)=x⁶²⊕x⁶⊕x⁵⊕x³⊕1 as the feedback function.

The outputs of XOR gate 108 and 106 are connected, parallel to the relevant feedback coupling, with the two inputs of a third XOR gate 110. The output of the third XOR gate 110 is conducted to UND gate 100 of the following decoding element 74.

All flip-flops of shift register R64 and R63 are synchronized by one common timing cycle from baud rate generator 98.

The sequence of output bits produced by sequence generator 96 has a period of 2¹²⁷−3*2⁶³+1. It means that the produced sequence of binary data will start from the beginning only after about 1.7*10³⁸ basic cycles. In this way, the identification of the binary key is practically impossible even if the feedback function is known.

FIG. 7 represents, in a block diagram, the control of shift registers R64 and R63 when a key is being transferred. Shift registers R64 and R63 are each divided into a number of sub-registers connected in series, which are marked with reference numbers R0 to R7, and R8 to R15 in FIG. 7. Each of the sub-registers R0 to R14 contains eight flip-flops F0 to F7, etc. Register R0 with flip-flops F0 to F7 is physically identical with key register 80. In case of sequence generator 84 of crypt unit 68, the register R0 is physically identical with key register 70. During the transfer of the key, with each write cycle into the key register, i.e., register R0, with a simultaneously activated write mode (RWE=1 and/or TWE=1) one byte is transported from the E-th register to the E+1-th register, where register R0 always receives one byte from internal data bus 56. As a result, 16 write cycles are required to transfer a 127-bit binary key. After a resetting procedure, shift registers R64 and R63 in sequence generators 84 and 96 of crypt UART component 50 contain random values. After a resetting procedure, the control bits of crypt control register 60 are set to zero. All other registers of crypt UART component have, after a resetting procedure, exactly those values shown by a conventional PC16550D type UART component.

Crypt UART component 50 offers the complete functionality of a conventional PC16550D type UART component. In addition, however, it has encoding and decoding capabilities. This allows an encoded data transmission during the communication with transmitters or receivers that also support such encoding process. If the external transmitters or receivers do not support such encoding, a non-encoded data transmission occurs according to conventional patterns.

TABLE I

| A2 | A1 | A0 | Write Mode | Read Mode |
|---|---|---|---|---|
| 0 | 0 | 0 | Receive Holding Register | Transmit Holding Register |
| | | | (RHR) | (THR) |
| 0 | 0 | 1 | | Interrupt Enable Register |
| | | | | (IER) |
| 0 | 1 | 0 | Interrupt Status Register | FIFO Control Register (FCR) |
| | | | (ISR) | |
| 0 | 1 | 1 | | Line Control Register (LCR) |
| 1 | 0 | 0 | | Modem Control Register |
| | | | | (MCR) |
| 1 | 0 | 1 | Line Status Register (LSR) | Crypt Control Register (CCR) |
| 1 | 1 | 0 | Modem Status Register | Key Register (KR) |
| | | | (MSR) | |
| 1 | 1 | 1 | Scratchpad Register (SPR) | Scratchpad Register (SPR) |
| 0 | 0 | 0 | LSB of Divisor Latch | LSB of Divisor Latch (DLL) |
| | | | (DLL) | |
| 0 | 0 | 1 | MSB of Divisor Latch | MSB of Divisor Latch (DLM) |
| | | | (DLM) | |

TABLE 2

| | | | | | | | | | |
|---|---|---|---|---|---|---|---|---|---|
| A2 A1 A0 | Register | Bit<7> | Bit<6> | Bit<5> | Bit<4> | Bit<3> | Bit<2> | Bit<1> | Bit<0> |

General UART-Register

| | | | | | | | | | |
|---|---|---|---|---|---|---|---|---|---|
| 0 0 0 | RHR | bit-7 | bit-6 | bit-5 | bit-4 | bit-3 | bit-2 | bit-1 | bit-0 |
| 0 0 0 | THR | bit-7 | bit-6 | bit-5 | bit-4 | bit-3 | bit-2 | bit-1 | bit-0 |
| 0 0 1 | IER | | | | | modem status | receive line | transmit | receiver holding |
| | | | | | | interrupt | status | holding | register |
| | | | | | | | interrupt | register | |
| 0 1 0 | ISR | FIFOs | FIFOs | | | INT | INT | INT | INT |
| | | enabled | enabled | | | priority | priority | priority | priority |
| | | | | | | bit-2 | bit-1 | bit-0 | |
| 0 1 0 | FCR | RCVR | RCVR | | | DMA | XMIT | RCVR | FIFO |
| | | trigger | trigger | | | mode | FIFO | FIFO | enable |
| | | (MSB) | (LSB) | | | select | reset | reset | |
| 0 1 1 | LCR | divisor latch | set | set | even | parity | stop | word | word |
| | | enable | break | parity | parity | enable | bits | length | length |
| | | | | | | | | bit-1 | bit-0 |
| 1 0 0 | MCR | | | | loop | −OP2 | −OP1 | −RTS | −DTR |
| | | | | | back | | | | |
| 1 0 1 | LSR | | trans. | trans. | break | framing | parity | overrun | receive |
| | | | empty | holding | interrupt | error | error | error | data |
| | | | | empty | | | | | ready |
| 1 0 1 | CCR | | | | | DE | EE | RWE | TWE |
| 1 1 0 | MSR | CD | RI | DSR | CTS | delta | delta | delta | delta |
| | | | | | | −CD | −RI | −DSR | −CTS |
| 1 1 0 | KR | bit-7 | bit-6 | bit-5 | bit-4 | bit-3 | bit-2 | bit-1 | bit-0 |
| 1 1 1 | SPR | bit-7 | bit-6 | bit-5 | bit-4 | bit-3 | bit-2 | bit-1 | bit-0 |

spezielle UART-Register

| | | | | | | | | | |
|---|---|---|---|---|---|---|---|---|---|
| 0 0 0 | DLL | bit-7 | bit-6 | bit-5 | bit-4 | bit-3 | bit-2 | bit-1 | bit-0 |
| 0 0 1 | DLM | bit-15 | bit-14 | bit-13 | bit-12 | bit-11 | bit-10 | bit-9 | bit-8 |

What is claimed is:

1. A transmitter for transmitting data of a first type consisting of binary-coded, serial data, the transmitter comprising
a data input designed to receive data of a pre-determined second type,
a data converter, connected with the data input, to convert the data of the second type into data of the first type, and
a data output, connected with the data converter. to release data of the first type, characterized by a means for encoding data of the first type into encoded data of the same type, located between the data converter and the data output.

2. The transmitter of claim 1, wherein the data converter comprises:
a transmit shift register connected with the encoding means for receiving binary-coded data and serially releasing binary-coded data.

3. The transmitter of claim 2, wherein the encoding means comprises:
a key register for receiving and releasing an adjustable binary key with a pre-determined number of bit positions.

4. The transmitter of claim 1, wherein the encoding means comprises:
a key register for receiving and releasing an adjustable binary key with a pre-determined number of bit positions.

5. The transmitter of claim 4, wherein the key register is connected with data input.

6. The transmitter of claim 3, wherein the key register is connected with data input.

7. The transmitter of claim 5, wherein the encoding means comprises:
an encoding element, connected on an input side thereof with the data converter, for encoding data received therefrom.

8. The transmitter of claim 6, wherein the encoding means comprises:
an encoding element, connected on an input side thereof with the data converter, for encoding data received therefrom.

9. The transmitter of claim 7, wherein the encoding element is connected on the input side with the key register.

10. The transmitter of claim 8, wherein the encoding element is connected on the input side with the key register.

11. The transmitter of claim 9, wherein the encoding means comprises:
a pseudo-random sequence generator for the generating and releasing a binary-coded pseudo-random sequence.

12. The transmitter of claim 10, wherein the encoding means comprises:
a pseudo-random sequence generator for the generating and releasing a binary-coded pseudo-random sequence.

13. The transmitter of claim 1 1, wherein the pseudo-random sequence generator is connected on an output side thereof with the encoding element.

14. The transmitter of claim 12, wherein the pseudo-random sequence generator is connected on an output side thereof with the encoding element.

15. The transmitter of claim 13, wherein the pseudo-random sequence generator is connected on an input side thereof with the key register.

16. The transmitter of claim 14, wherein the pseudo-random sequence generator is connected on an input side thereof with the key register.

17. A transmitter for transmitting data of a first type consisting of binary-coded, serial data, the transmitter comprising
a data input designed to receive data of a pre-determined second type,
a data converter, connected with the data input, to convert the data of the second type into data of the first type, the data converter comprising a transmit shift register connected with the encoding means for receiving binary-coded data and serially releasing binary-coded data; and
a data output, connected with the data converter. to release data of the first type, characterized by a means for encoding data of the first type into encoded data of the same type, located between the data converter and the data output.;
the encoding means comprising a key register for receiving and releasing an adjustable binary key with a pre-determined number of bit positions;
the key register being connected with data input;
the encoding means further comprising an encoding element, connected on an input side thereof with the data converter, for encoding data received therefrom.
the encoding element further connected on the input side with the key register;
the encoding means further comprising a pseudo-random sequence generator for the generating and releasing a binary-coded pseudo-random sequence.
the pseudo-random sequence generator being connected on an output side thereof with the encoding element; and
the pseudo-random sequence generator further connected on an input side thereof with the key register.

18. A receiver for receiving data of a first type containing binary-coded, serial data, the receiver comprising:
a data input for receiving data of the first type;
a data converter connected with the data input for convert data of the first type into data of a second type;
a data output connected with the data converter for releasing data of the second type, characterized by a means for decoding to convert encoded data of the first type into non-encoded data of the first type, located between the data input and the data converter.

19. The receiver of claim 18, wherein the data converter comprises:
a receive shift register to serially receive and release binary-coded data.

20. The receiver of claim 18, wherein the decoding means comprises:
a key register for receiving an adjustable binary key with a pre-determined number of bit positions.

21. The receiver of claim 19, wherein the decoding means comprises:
a key register for receiving an adjustable binary key with a pre-determined number of bit positions.

22. The receiver of claim 20, wherein the key register is connected with the data input.

23. The receiver of claim 21, wherein the key register is connected with the data input.

24. The receiver of claim 20, wherein the key register is connected with the data output.

25. The receiver of claim 21, wherein the key register is connected with the data output.

26. The receiver of claim 22, wherein the key register is connected with the data output.

27. The receiver of claim 23, wherein the key register is connected with the data output.

28. The receiver of claim 18, wherein the decoding means comprises:
a decoding element, connected on an output side thereof with the data converter, for decoding data received from the data input.

29. The receiver of claim 24, wherein the decoding means comprises:
a decoding element, connected on an output side thereof with the data converter, for decoding data received from the data input.

30. The receiver of claim 25, wherein the decoding means comprises:
a decoding element, connected on an output side thereof with the data converter, for decoding data received from the data input.

31. The receiver of claim 26, wherein the decoding means comprises:
a decoding element, connected on an output side thereof with the data converter, for decoding data received from the data input.

32. The receiver of claim 27, wherein the decoding means comprises:
a decoding element, connected on an output side thereof with the data converter, for decoding data received from the data input.

33. The receiver of claim 29, wherein the decoding element is connected on an input side thereof with the key register.

34. The receiver of claim 30, wherein the decoding element is connected on an input side thereof with the key register.

35. The receiver of claim 31, wherein the decoding element is connected on an input side thereof with the key register.

36. The receiver of claim 32, wherein the decoding element is connected on an input side thereof with the key register.

37. The receiver of claim 18, wherein the decoding means comprises a pseudo-random sequence generator to generate and release a binary-coded pseudo-random sequence.

38. The receiver of claim 35, wherein the decoding means comprises a pseudo-random sequence generator to generate and release a binary-coded pseudo-random sequence.

39. The receiver of claim 36, wherein the decoding means comprises a pseudo-random sequence generator to generate and release a binary-coded pseudo-random sequence.

40. The receiver of claim 34, wherein the decoding means comprises a pseudo-random sequence generator to generate and release a binary-coded pseudo-random sequence.

41. The receiver of claim 33, wherein the decoding means comprises a pseudo-random sequence generator to generate and release a binary-coded pseudo-random sequence.

42. The receiver of claim 37, wherein the pseudo-random sequence generator is connected on an output side thereof with the de coding element.

43. The receiver of claim 38, wherein the pseudo-random sequence generator is connected on an output side thereof with the decoding element.

44. The receiver of claim 39, wherein the pseudo-random sequence generator is connected on an output side thereof with the decoding element.

45. The receiver of claim 40, wherein the pseudo-random sequence generator is connected on an output side thereof with the decoding element.

46. The receiver of claim 41, wherein the pseudo-random sequence generator is connected on an output side thereof with the decoding element.

47. The receiver of claim 43, wherein the pseudo-random sequence generator is connected on an input side thereof with the key register.

48. The receiver of claim 44, wherein the pseudo-random sequence generator is connected on an input side thereof with the key register.

49. The receiver of claim 45, wherein the pseudo-random sequence generator is connected on an input side thereof with the key register.

50. The receiver of claim 46, wherein the pseudo-random sequence generator is connected on an input side thereof with the key register.

51. The transmitter of claim 16, further comprising:
a crypt control register connected on an output side thereof with the encoding element to receive and release of binary-coded control data.

52. The receiver of claim 48, further comprising:
a crypt control register connected, on an output side thereof with the decoding element to receive and release of binary-coded control data.

53. The transmitter of claim 51, wherein the crypt control register is connected with the key register.

54. The receiver of claim 52, wherein the crypt control register is connected with the key register.

55. The transmitter of claim 53, wherein the crypt control register is connected with the pseudo-random sequence generator.

56. The receiver of claim 54, wherein the crypt control register is connected with the pseudo-random sequence generator.

57. The transmitter of claim 55, wherein the pseudo-random sequence generator comprises:
a sequence generator circuit having a regenerative shift register with a feedback circuit.

58. The receiver of claim 56, wherein the pseudo-random sequence generator comprises:
a sequence generator circuit having a regenerative shift register with a feedback circuit.

59. The transmitter of claim 57, wherein the feedback circuit defines a linear feedback function.

60. The receiver of claim, wherein the feedback circuit defines a linear feedback function.

61. The transmitter of claim 57, wherein the feedback circuit defines a feedback function that is a primitive polynomial modulo two.

62. The receiver of claim according to claim 58, wherein the feedback circuit defines a feedback function that is a primitive polynomial modulo two.

63. The transmitter of claim 57, wherein the shift register of the sequence generator circuit is designed so that a part of the shift register simultaneously assumes the function of the key register.

64. The receiver of claim 58, wherein the shift register of the sequence generator circuit is designed so that a part of the shift register simultaneously assumes the function of the key register.

65. The transmitter of claim 63, wherein the shift register of the sequence generator circuit comprises at least a first and a last sub-register connected in series for chronologically parallel reception of a part of the binary key consisting of a pre-determined number of bit positions, where the las sub-register in sequence provides a serial release of the part of the binary key contained therein, and the other sub-registers provide a chronologically parallel release of the part of the binary key contained in each of them to the sub-register that follows in sequence.

66. The receiver of claim 64, wherein the shift register of the sequence generator circuit comprises at least a first and a last sub-register connected in series for chronologically parallel reception of a part of the binary key consisting of a pre-determined number of bit positions, where the las sub-register in sequence provides a serial release of the part of the binary key contained therein, and the other sub-registers provide a chronologically parallel release of the part of the binary key contained in each of them to the sub-register that follows in sequence.

67. The transmitter of claim 65, wherein the shift register of the sequence generator circuit comprises at least a first and a last flip-flop connected in series so that the first flip-flop first in sequence is assigned the highest-value bit position, the second flip-flop connected on an input side therof with an output of the first flip-flop is assigned the next lower-value bit position, and so forth until the last flip-flop is assigned the least-value (“least significant”) bit position.

68. The receiver of claim 66, wherein the shift register of the sequence generator circuit comprises at least a first and a last flip-flop connected in series so that the first flip-flop first in sequence is assigned the highest-value bit position, the second flip-flop connected on an input side therof with an output of the first flip-flop is assigned the next lower-value bit position, and so forth until the last flip-flop is assigned the least-value (“least significant”) bit position.

69. The transmitter of claim 67, wherein the sequence generator circuit comprises:
a first XOR gate that follows the last flip-flop of the shift register, with at least two inputs thereof connected to the outputs of pre-determined flip-flops, and with an output connected with the input of the first flip-flop and with the data output of the transmitter.

70. The receiver of claim according to claim 68, wherein the sequence generator circuit comprises:
a first XOR gate that follows the last flip-flop of the shift register, with at least two inputs thereof connected to the outputs of predetermined flip-flops, and with an output connected with the input of the first flip-flop and with the receive shift register of the receiver.

71. The transmitter of claim 69, wherein that the sequence generator circuit comprises:
a 64-bit shift register, where the outputs of the first flip-flop, of the penultimate flip-flop and of the last flip-flop are connected with the first XOR gate.

72. The transmitter of claim 69, wherein that the sequence generator circuit comprises:
a 64-bit shift register, where the outputs of the first flip-flop, of the penultimate flip-flop and of the last flip-flop are connected with the first XOR gate.

73. The transmitter of claim 69, wherein the sequence generator circuit comprises:
a 63-bit shift register where the outputs of the first flip-flop, of the fifty seventh flip-flop, of the fifty eighth flip-flop, of the sixtieth flip-flop and of the sixty third flip-flop thereof are each connected with one input of a second XOR gate, and
the output of the second XOR gate is connected with the data output of the transmitter.

74. The receiver of claim 70, wherein the sequence generator circuit comprises:
a 63-bit shift register where the outputs of the first flip-flop, of the fifty seventh flip-flop, of the fifty eighth flip-flop, of the sixtieth flip-flop and of the sixty third flip-flop thereof are each connected with one input of a second XOR gate, and
the output of the second XOR gate is connected with the receive shift register of the receiver.

75. The transmitter of claim 73, wherin the sequence generator circuit comprises:
a third XOR gate, to whose inputs are connected the output of the first XOR gate and the output of the second XOR gate,
where the output of the third XOR gate is connected with the data output of the transmitter.

76. The receiver of claim 74, wherin the sequence generator circuit comprises:
a third XOR gate, to whose inputs are connected the output of the first XOR gate and the output of the second XOR gate,
where the output of the third XOR gate is connected with the receive shift register of the receiver.

77. The transmitter of claim 75, wherein the encoding element comprises:
a fourth XOR gate to whose inputs are connected the output of the third XOR gate and the data converter of the transmitter, and whose output is connected with the data output of the transmitter.

78. The receiver of claim 76, wherein the decoding element comprises:
a fourth XOR gate to whose inputs are connected the output of the third XOR gate and the data input of the receiver, and whose output is connected with the data converter of the receiver.

79. The transmitter of claim 77, further comprising:
a baud rate generator that is connected on an output side thereof, in a parallel arrangement with the data converter and the encoding means to generate and release a timing signal with a pre-determinable frequency.

80. The receiver of claim 78, further comprising:
a baud rate generator that is connected on an output side therof, in a parallel arrangement with the data converter and the decoding means to generate and release a timing signal with a pre-determinable frequency.

81. The transmitter of claim 79, comprising:
a sequence generator circuit, the operation of which is activated or deactivated by a control bit contained in the crypt control register.

82. The receiver of claim 80, comprising:
a sequence generator circuit, the operation of which is activated or deactivated by a control bit contained in the crypt control register.

83. The transmitter of claim 81, wherein the key register is circuited so that the write access to the key register is activated or deactivated by a control bit contained in the crypt control register.

84. The receiver of claim 82, wherein the key register is circuited so that the write access to the key register is activated or deactivated by a control bit contained in the crypt control register.

85. The transmitter of claim 61, wherein its components are integrated in a transmitter component.

86. The receiver of claim 62, wherein its components are integrated in a receiver component.

87. A transceiver arrangement, comprising:
a transmitter unit for transmitting data of a first type consisting of binary-coded, serial data, comprising:
a data input designed to receive data of a pre-determined second type,
a data converter, connected with the data input, to convert the data of the second type into data of the first type, the data converter comprising a transmit shift register connected with the encoding means for receiving binary-coded data and serially releasing binary-coded data; and
a data output, connected with the data converter. to release data of the first type, characterized by a means for encoding data of the first type into encoded data of the same type, located between the data converter and the data output.;
the encoding means comprising a key register for receiving and releasing an adjustable binary key with a pre-determined number of bit positions;
the key register being connected with data input;
the encoding means further comprising an encoding element, connected on an input side thereof with the data converter, for encoding data received therefrom.
the encoding element further connected on the input side with the key register;
the encoding means further comprising a pseudo-random sequence generator for the generating and releasing a binary-coded pseudo-random sequence.
the pseudo-random sequence generator being connected on an output side thereof with the encoding element; and
the pseudo-random sequence generator further connected on an input side thereof with the key register, and
a receiver unit for receiving data of a first type containing binary-coded, serial data, comprising:
a data input for receiving data of the first type;
a data converter connected with the data input for convert data of the first type into data of a second type, comprising a receive shift register to serially receive and release binary-coded data;
a data output connected with the data converter for releasing data of the second type, characterized by a means for decoding to convert encoded data of the first type into non-encoded data of the first type, located between the data input and the data converter;
the decoding means comprising a key register for receiving an adjustable binary key with a pre-determined number of bit positions;
the key register being connected with the data input;
the decoding means further comprising a decoding element, connected on an output side thereof with the data converter, for decoding data received from the data input;
the decoding element being connected on an input side thereof with the key register;
the decoding means further comprising a pseudo-random sequence generator to generate and release a binary-coded pseudo-random sequence;
the pseudo-random sequence generator being connected on an output side thereof with the decoding element; and
the pseudo-random sequence generator being connected on an input side thereof with the key register.

88. The transceiver arrangement of claim 87, wherein the data input of the transmitter unit is designed for the reception of binary-coded (parallel) data structures containing several chronologically parallel proceeding bit positions, that the data converter of the transmitter unit is a parallel/serial converter designed to convert a parallel data structure into serial data, and that the data converter of the receiver unit is a serial/parallel converter designed to convert serial data into a parallel data structure.

89. The transceiver arrangement of claim 88, comprising:
a UART (Universal Asynchronous Receiver Transmitter) component.

90. The transceiver arrangement of claim 89, comprising:
a register record and a control data record, which contains all register and control data of a type PC16550D UART component.

91. The transceiver arrangement of claim 90, characterized by an addressing of the key register and the crypt control register in a read mode and a write mode compatible with a PC16550D type UART component.

92. A receiver for receiving data of a first type containing binary-coded, serial data, the receiver comprising:
a data input for receiving data of the first type;
a data converter connected with the data input for convert data of the first type into data of a second type, comprising a receive shift register to serially receive and release binary-coded data;
a data output connected with the data converter for releasing data of the second type, characterized by a means for decoding to convert encoded data of the first type into non-encoded data of the first type, located between the data input and the data converter;
the decoding means comprising a key register for receiving an adjustable binary key with a pre-determined number of bit positions;
the key register being connected with the data input;
the decoding means further comprising a decoding element, connected on an output side thereof with the data converter, for decoding data received from the data input;
the decoding element being connected on an input side thereof with the key register;
the decoding means further comprising a pseudo-random sequence generator to generate and release a binary-coded pseudo-random sequence;
the pseudo-random sequence generator being connected on an output side thereof with the decoding element;
the pseudo-random sequence generator being connected on an input side thereof with the key register.
